(19) United States
(12) Patent Application Publication
(10) Pub. No.: US 2025/0117787 A1
(43) Pub. Date: Apr. 10, 2025

(54) METHOD AND SYSTEM OF STORING DYNAMIC CREDIT CARD NUMBERS ON E-COMMERCE PLATFORMS USING BLOCKCHAIN TECHNOLOGY

(71) Applicant: Mastercard International Incorporated, Purchase, NY (US)

(72) Inventors: Nishant MAHESHWARI, Delhi (IN); Amit GUPTA, New Delhi (IN)

(73) Assignee: Mastercard International Incorporated, Purchase, NY (US)

(21) Appl. No.: 18/376,957

(22) Filed: Oct. 5, 2023

(51) Int. Cl. G06Q 20/38; G06Q 20/40

(52) U.S. Cl. CPC G06Q 20/383; G06Q 20/385; G06Q 20/389; G06Q 20/40

(57) ABSTRACT

A method for establishing payment via a dynamic card number using blockchain to protect consumer privacy includes: receiving transaction details for a proposed payment transaction including a transaction amount and primary payment details, wherein the primary payment details are associated with a transaction account; identifying a transaction identifier for the proposed payment transaction and dynamic payment details, wherein the dynamic payment details are separate and distinct from the primary payment details; generating a first blockchain data entry including the transaction identifier, primary payment details, dynamic payment details, and transaction amount; generating a second blockchain data entry including the transaction identifier, dynamic payment details, and transaction amount; and transmitting the first blockchain data entry and the second blockchain data entry to at least one blockchain node of at least one blockchain network.

### FIELD

The present disclosure relates to storing dynamic credit card numbers using blockchain technology, specifically the use of reusable, dynamic credit card numbers stored on a blockchain to prevent fraud and protect consumer privacy.

### BACKGROUND

Credit cards and other types of payment cards are used in upwards of one billion transactions per day, being the most preferred payment method for the average consumer. As a result, there is a wealth of data and information that can be gained from analyzing the usage of payment cards, both on an individual level and a wider, consumer level. Merchants and financial institutions often use this type of data to operate loyalty programs, provide additional services, and highlight desirable new products for purchase. Because of the value of this data, some entities are in the business of selling such data.

In some cases, a consumer can be unable to prevent the gathering and/or sale of such data. If a merchant or other service provider fails to provide the ability for a consumer to opt-out of such data collection or sale, the consumer can only transact with that provider with the knowledge that their transaction behavior will be collected and sold. Currently, the only options to avoid such a situation for a consumer are to use a different merchant, which can be difficult or impossible for consumers in remote location or that are purchasing uncommon goods or services, or to use a variety of different accounts and/or payment methods, which can also be exceedingly complicated or difficult for a consumer. Thus, there is a need for a technical solution to enable a consumer to interact freely with merchants in e-commerce transactions without the need to utilize multiple accounts or payment methods while protecting consumer data privacy.

### SUMMARY

The present disclosure provides a description of systems and methods for establishing payment via a dynamic card number using blockchain in order to protect consumer data. Using a specialized platform, a consumer can use a familiar payment card when transacting with a merchant. The platform can identify a dynamic card number, which can be reused across multiple merchants and multiple consumers, that can be used for that specific transaction. To accomplish this, two blocks are created in one or more blockchains: a first block that has details for the real payment card, the dynamic payment card, and transaction data, and a second block that has only the dynamic payment card and transaction data. The transaction is processed using the dynamic payment card, where the merchant can view only the second block to verify the payment details, but where the issuer of the real payment card can view the first block to ensure the linkage between the dynamic payment card and real payment card. As a result, the consumer can transact freely using a familiar payment method, but where the merchant is unable to track data due to the dynamic card number, as each transaction can have a unique card number used and where the reuse of a card number is agnostic as to the transacting consumer. Use of a blockchain to store the data provides for verification for all entities involved and can ensure that an issuer can still identify the real payment card when a chargeback or other later message is received from the issuer, without the need for modifications to existing issuer systems. The result is a more convenient and secure system for consumers without changing existing, familiar payment processing.

A method for establishing payment via a dynamic card number using blockchain to protect consumer privacy includes: receiving, by a receiver of a processing server, transaction details for a proposed payment transaction, the transaction details including at least a transaction amount and primary payment details, wherein the primary payment details are associated with a transaction account; identifying, by a processor of the processing server, a transaction identifier for the proposed payment transaction and dynamic payment details, wherein the dynamic payment details are separate and distinct from the primary payment details; generating, by the processor of the processing server, a first blockchain data entry including at least the transaction identifier, primary payment details, dynamic payment details, and transaction amount; generating, by the processor of the processing server, a second blockchain data entry including at least the transaction identifier, dynamic payment details, and transaction amount; and transmitting, by a transmitter of the processing server, at least the first blockchain data entry and the second blockchain data entry to at least one blockchain node of at least one blockchain network.

A system for establishing payment via a dynamic card number using blockchain to protect consumer privacy includes: at least one blockchain node; at least one blockchain network including the at least one blockchain node; and a processing server, the processing server including a receiver receiving transaction details for a proposed payment transaction, the transaction details including at least a transaction amount and primary payment details, wherein the primary payment details are associated with a transaction account, a processor identifying transaction identifier for the proposed payment transaction and dynamic payment details, wherein the dynamic payment details are separate and distinct from the primary payment details, generating a first blockchain data entry including at least the transaction identifier, primary payment details, dynamic payment details, and transaction amount, and generating a second blockchain data entry including at least the transaction identifier, dynamic payment details, and transaction amount, and a transmitter transmitting at least the first blockchain data entry and the second blockchain data entry to at least one blockchain node of at least one blockchain network.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for establishing payment via a dynamic card number using blockchain to protect consumer privacy in accordance with exemplary embodiments.

FIG. 2 is a block diagram illustrating the processing server in the system of FIG. 1 for establishing payment via a dynamic card number using blockchain in accordance with exemplary embodiments.

FIGS. 3A and 3B are a flow diagram illustrating a process for establishing payment via a dynamic card number using blockchain in the system of FIG. 1 in accordance with exemplary embodiments.

FIG. 4 is a flow chart illustrating an exemplary method for establishing payment via a dynamic card number using blockchain to protect consumer privacy in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

### System for Processing Transactions via Dynamic Card Numbers and Blockchain

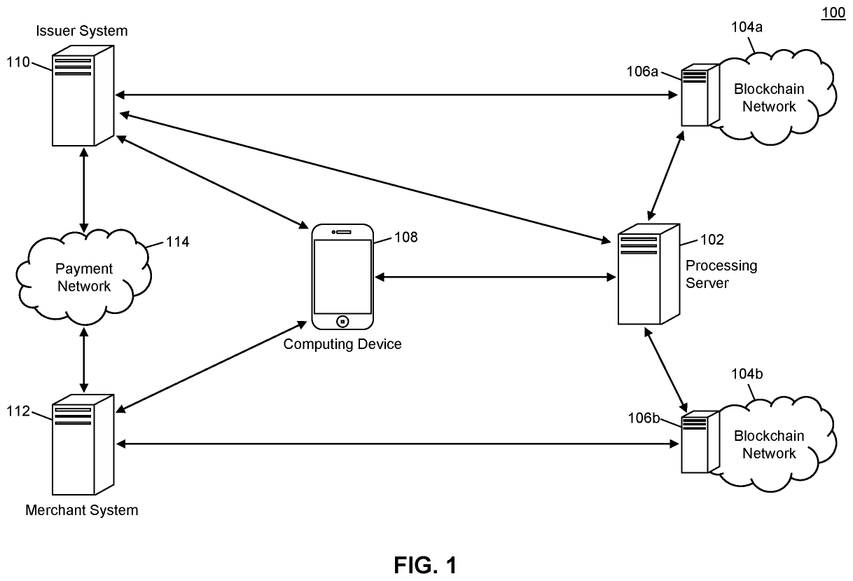

FIG. 1 illustrates a system 100 for the processing of electronic payment transactions through the use of dynamic card numbers and blockchain in order to protect consumer data privacy while also preventing fraud. The system 100 can include a processing server 102. The processing server 102, discussed in more detail below, can provide a platform that is used by consumers to receive dynamic card numbers for use in electronic payment transactions, where the platform stores relevant data in one or more blockchains to facilitate the initial electronic payment transaction and any subsequent activity and prevent data collection for the consumer.

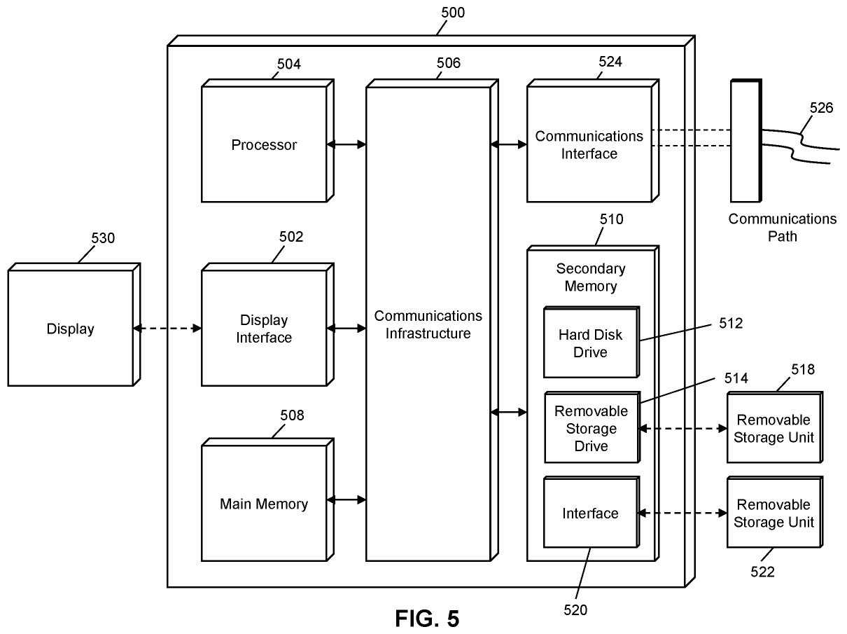

The system 100 can also include one or more blockchain networks 104, illustrated in FIG. 1 as first blockchain network 104a and second blockchain network 104b. The blockchain networks 104 can be comprised of a plurality of blockchain nodes 106. Each blockchain node 106 can be a computing system, such as illustrated in FIG. 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. In some embodiments, the processing server 102 can be a blockchain node 106 in the first blockchain network 104a and/or the second blockchain network 104b.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 106 in a blockchain network 104 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the respective blockchain network 104 using the public key of the cryptographic key pair. In some cases, the term “blockchain wallet” can refer specifically to the private key. In other cases, the term “blockchain wallet” can refer to a computing device that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of that is generated using the sender's private key, a blockchain address of the recipient of currency generated using the recipient's public key, and a blockchain currency amount that is transferred, or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in a blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104 before being added to the blockchain and distributed to all of the blockchain nodes 106 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

In the system 100, access to the blockchains associated with the blockchain networks 104a and 104b can be restricted. In an exemplary embodiment, only authorized entities can be permitted to submit new blockchain data for addition to the blockchain, such as the processing server 102. In such embodiments, the blockchains can be considered to be permissioned blockchains. In some cases, the first blockchain network 104a can be a private blockchain, where the blocks in the blockchain are not publicly accessible, but are only accessible by authorized parties, as discussed below. The blockchain associated with the blockchain network 104b may be a permissioned blockchain where the blocks are publicly accessible. In some embodiments, the system 100 can include a single blockchain network 104 that operates both a first, private blockchain and a second, permissioned blockchain.

In the system 100, the first and second blockchains can be configured to store data regarding electronic payment transactions, as discussed herein. In the system 100, a consumer can be interested in conducting an electronic payment transaction with a merchant for the purchase of goods or services. The consumer, represented in the system 100 by the computing device 108, can electronically transmit a transaction request to the processing server 102 using a suitable communication network and method. The computing device 108 can be any type of device suitable for performing the functions discussed herein, such as a cellular phone, smart phone, desktop computer, laptop computer, tablet computer, smart watch, smart television, wearable computing device, implantable computing device, etc. The computing device 108 can submit the transaction request via a web page, application program, or other suitable method.

The computing device 108 can submit the transaction request to the processing server 102 for an electronic payment transaction where the consumer is interested in using a dynamic card number. The computing device 108 can provide, in the transaction request, at least the transaction amount and payment details for the payment card the consumer is interested in using to fund the electronic payment transaction, referred to herein as the “real” payment card, as it is the payment card directly associated with the actual transaction account that will be used to fund the electronic payment transaction. The payment details can include a card number, expiration date, name, billing address, security code, and/or any other suitable data. Other transaction data for the desired payment transaction can also be included in the transaction request, such as a merchant identifier associated with the merchant with whom the consumer is interested in transacting, a timestamp, etc. In embodiments, a consumer using the computing device 108 may submit the transaction request via a website associated with a merchant, e.g., the merchant system 112, or a consumer using the computing device 108 may select an option on a website associated with a merchant, e.g., the merchant system 112, to transact using a secure payment option and the website may redirect the consumer to a separate website for submitting the transaction request.

The system 100 can include an issuer system 110. The issuer system 110 can be a computing system of an issuer, which can be a financial institution, such as an issuing bank, or other entity that issues the real transaction account to the consumer for use in funding electronic payment transactions. As part of the issuing of the transaction account, the issuer system 110 can issue a payment card to the consumer (e.g., including a virtual payment card issued directly to the computing device 108) that includes payment details. The payment details for the real payment card included in the transaction request can include any data provided by the issuer system 110 or otherwise specified thereby for use in conducting e-commerce via electronic payment transactions.

Once the transaction request is received, the processing server 102 can identify a transaction identifier for the proposed electronic payment transaction as well as a dynamic card number. The transaction identifier can be a value that is unique to the electronic payment transaction and used for a reference thereof in communications regarding the electronic payment transaction in the system 100. The transaction identifier can be a numeric, alphanumeric, or other type of value of suitable length. In some cases, the transaction identifier can be randomly generated. In other cases, the transaction identifier can be identified and assigned from a pool of unused transaction identifiers. The dynamic card number can be a card number that is different from the card number for the real transaction account that will be provided to merchants and other entities involved in the electronic payment transaction to prevent use of the real payment details. The dynamic card number can be formatted in the same manner as the real card number. In some cases, a portion of the dynamic card number can indicate that the card number is a dynamic card number, such as where a bank identification number in the dynamic card number indicates a dynamic card number. In some cases, each issuer system 110, which has a traditional, unique bank identification number associated therewith, can have a unique, bank identification number associated therewith used for dynamic card numbers. The dynamic card number may be a non-unique number, e.g., alphanumeric character string, that is generated in response to the transaction request for that specific transaction, but which may be used by the same or a different consumer for a subsequent transaction. For example, the dynamic card number generated in response to a transaction request from consumer “A” for transaction “X” may be used again later for a transaction request from consumer “B” for transaction “Y.” In this case, the dynamic payment number is non-unique in that it can be re-used by the same consumer or a different consumer. In embodiments, the dynamic card number may be a unique number, e.g., alphanumeric character string, that is generated for each transaction request such that each transaction can be traced using the unique dynamic payment number. In embodiments, the dynamic card number may be user-generated. For example, a user may generate the dynamic card number and submit the user-generated dynamic card number with the transaction request.

In some embodiments, dynamic card numbers can be reused by the processing server 102. In such embodiments, the processing server 102 can identify a dynamic card number that was previously used in a prior electronic payment transaction. In such cases, the association of the dynamic card number with a real payment card can be identified, as discussed below, via other accompanying transaction details, such as a timestamp, time and/or date, etc. In these embodiments, the dynamic card number can be identified from a pool of available dynamic card numbers, where there can be one or more restrictions on when a dynamic card number can be reused, such as a predetermined period of time, where the dynamic card number must be used at a different merchant from the previous merchant, the transaction amount must be outside of a predetermined range from the transaction amount of the last transaction, etc. In other embodiments, the processing server 102 can generate a unique dynamic card number that has never been used before or identify an unused dynamic card number from a pool of unused dynamic card numbers. In some instances, the processing server 102 can identify additional payment details for use with the dynamic card number, referred to herein as dynamic payment details, such as an expiration date, security code, etc. that, when used with the dynamic card number, will result in successful authentication and/or verification thereof during transaction processing. In embodiments where the dynamic card number is user-generated, the user may designate a specific merchant, e.g., the merchant system 112, that the user-generated dynamic card number is to be used to transact with. For example, a user may transact with three different merchants using the same primary card number and the user may generate three different dynamic card numbers to be associated with the same primary card number, with each different dynamic card number being associated with a specific merchant. The user-generated dynamic card numbers and their associated specific merchants may be stored in an account profile of the user, e.g., one of the account profiles 208, as discussed in more detail below.

Once the dynamic card number is identified, the processing server 102 can generate two blockchain data entries for the electronic payment transaction. The first blockchain data entry, generated for the first blockchain, can include the transaction identifier, transaction amount and any other transaction data, the real payment details, and the dynamic payment details. The second blockchain data entry, generated for the second blockchain, can include the transaction identifier, transaction amount and any other transaction data, and the dynamic payment details. The processing server 102 can electronically transmit the first blockchain data entry and the second blockchain data entry to one or more blockchain nodes 106 for validation and confirmation of the data entry for inclusion in a new block in the appropriate blockchain. In embodiments where a single blockchain network 104 operates both blockchains, the processing server 102 can electronically transmit both blockchain data entries to a single blockchain node 106 in that blockchain network 104. In embodiments where each blockchain is operated by a different blockchain network 104, the processing server 102 can electronically transmit the first blockchain data entry to a blockchain node 106a in the first blockchain network 104a and the second blockchain data entry to a blockchain node 106b in the second blockchain network 104b.

Each blockchain node 106 that receives a new blockchain data entry can validate the received data using traditional methods. If the data is validated successfully, the new blockchain data entry can be added to a new block that is generated, confirmed, and added to the respective blockchain using traditional methods. Once the first and second blockchain data entries have been added to the first and second blockchains, the electronic payment transaction can be initiated. In some embodiments, the processing server 102 can electronically transmit the dynamic payment details to the computing device 108. In other embodiments where the dynamic payment number is user-generated, the processing server 102 can electronically transmit to the computing device 108 a confirmation that the user-generated dynamic payment number is approved for use. For example, the processing server 102 may verify that the user-generated dynamic payment number is not in use by another consumer, e.g., by querying the account database 206 as discussed in more detail below. The computing device 108 can then submit the dynamic payment details to a merchant system 112 in place of the real payment details when initiating the electronic payment transaction. For example, the computing device 108 may be using an application program or website for the merchant. When the consumer is to provide their payment details, the computing device 108 can (e.g., automatically or via user input) provide the dynamic payment details instead of the real payment details. In some cases, the computing device 108 can be configured, such as through an application program associated with the processing server 102 used to facilitate use of the platform, to automatically submit the dynamic payment details to the merchant system 112 during submission of the transaction.

In some embodiments, the processing server 102 can be configured to perform seamless, automatic generation and use of dynamic payment details. In such an embodiment, the consumer can, via the merchant website or application program, enter their real payment details in the appropriate areas on a submission form during checkout of their e-commerce transaction. When the computing device 108 submits the form, the application program associated with the processing server 102 can intercept the real payment details and replace the real payment details with dynamic payment details, where the submission to the merchant system 112 can complete with the dynamic payment details. The computing device 108 can then electronically transmit the transaction request to the processing server 102 that includes the real payment details, dynamic payment details, and transaction data. In such cases, the dynamic payment details can have been previously provided to the computing device 108 for use in its next electronic payment transaction. In other cases, the computing device 108 can automatically transmit the transaction request once submission is initiated, where the dynamic card details can be returned by the processing server 102 as discussed above before transmission of the data is made to the merchant system 112.

As a result of the initiation of the electronic payment transaction, the dynamic payment details and any other transaction data can be electronically transmitted to the merchant system 112. The merchant system 112 can be a computing system associated with a merchant that is used in the conducting and processing of e-commerce transactions for the merchant via the Internet or other network(s). The merchant system 112 can receive the data and initiate the processing of an electronic payment transaction for the appropriate transaction amount and where the dynamic payment details are used as the payment method. Initiation of the electronic payment transaction can include the generation and submission of an authorization request, a specially formatted transaction message, to a payment network 114 via payment rails associated therewith, directly from the merchant system 112 or through one or more intermediary systems, such as an acquiring financial institution system. Steps and processes for the processing of an electronic payment transaction will be apparent to persons having skill in the relevant art.

The payment network 114 can receive the authorization request and process the payment transaction. The payment network 114 can, via the dynamic card number, identify the issuer system 110 as having issued the transaction account to be used to fund the electronic payment transaction and route, via the payment rails, the authorization request to the issuer system 110 for approval or denial. The issuer system 110 can receive the authorization request that includes the dynamic payment details and identify the real transaction account. In some embodiments, the issuer system 110 can access the first blockchain and identify the first blockchain data entry that had been submitted by the computing device 108. The first blockchain data entry can be identified via the dynamic payment details being included therein as well as other transaction details included in the first blockchain data entry that match transaction data in the authorization request, such as transaction amount, merchant identifier, time and/or date, etc. In some cases, the issuer system 110 can request the real payment details from the processing server 102 by providing the dynamic payment details and other transaction data used for identification. The issuer system 110 can then identify the real payment details included therein and approve or deny the funding of the payment transaction via the transaction account associated with the real payment details using traditional methods. Upon approval of the payment transaction, the issuer system 110 can return an authorization response to the payment network 114 via the payment rails associated therewith that indicate approval of the payment transaction.

The payment network 114 can forward the authorization response to the merchant system 112. The merchant system 112 can, after identifying that the transaction was approved, finalize the payment transaction by providing the purchased goods or services to the consumer. The merchant system 112 can provide a receipt or other notification to the computing device 108 indicating the successful transaction. The result is an e-commerce transaction with a dynamic card number that cannot be linked to the consumer by the merchant, but where the consumer still uses their desired transaction account for payment, without the need for complicated account controls or multiple user accounts.

In some embodiments, the merchant system 112 can use the second blockchain for verification of a dynamic card number and other transaction data during the process discussed above. In such embodiments, when the computing device 108 submits the transaction to the merchant system 112, the merchant system 112 can identify the second blockchain data entry in the second blockchain that includes the dynamic payment details and other transaction data, such as to verify that the transaction data is correct. For instance, the merchant system 112 can be interested in verifying that the transaction amount submitted by the computing device 108 to the processing server 102 is accurate.

In some embodiments, the blockchain data entries transmitted to the blockchain nodes 106 by the processing server 102 can be placed in new blocks that are initially left open. In such embodiments, the blocks can remain open, e.g., not submitted for confirmation/validation by the blockchain networks 104, until the computing device 108 provides a specific authorization to proceed with the electronic payment transaction. In an example, the computing device 108 can submit the transaction request to the processing server 102 where the processing server 102 can transmit the new blockchain data entries to the respective blockchain nodes 106 and return the dynamic payment details to the computing device 108. The blocks can remain open in the blockchains until the consumer provides, via the computing device 108, authentication data, such as a one-time password, for verification, at which time the processing server 102 can inform the blockchain nodes 106 accordingly and the blocks can be closed, e.g., submitted for confirmation/validation by the blockchain networks 104. In another example, when the computing device 108 submits the transaction to the merchant system 112, the computing device 108 can also provide authorization to the processing server 102, such as during swapping of real payment details with dynamic payment details, as discussed above, which can initiate closing of the blocks. In these embodiments, the blockchain data entries can also include status identifiers, which can indicate the status of the requested electronic payment transaction. In such embodiments, the status identifier can indicate the transaction was proposed while the block is open, with the status identifier being changed to indicate that the transaction was submitted when the block is being closed. Further, the status identifier can indicate whether the transaction was a success, e.g., approved, or a failure, e.g., denied. In such cases, the issuer system 110 can view the status identifiers in blockchain data entries when identifying the blockchain data entry for use in identifying real payment details, where blockchain data entries with status identifiers indicating that the transaction was only proposed can be ignored.

In some embodiments, the first and second blockchain data entries may not be transmitted to the blockchain nodes 106 until the computing device 108 provides a specific authorization to proceed with the electronic payment transaction. In an example, the computing device 108 can submit the transaction request to the processing server 102 where the processing server 102 can generate the new blockchain data entries and return the dynamic payment details to the computing device 108. The data entries can remain open at the processing server 102 until the consumer provides, via the computing device 108, authentication data, such as a one-time password, for verification, at which time the processing server 102 can transmit the blockchain data entries to the blockchain nodes 106. In another example, when the computing device 108 submits the transaction to the merchant system 112, the computing device 108 can also provide authorization to the processing server 102, such as during swapping of real payment details with dynamic payment details, as discussed above, which can initiate closing of the data entries. In these embodiments, the blockchain data entries can also include status identifiers, which can indicate the transaction was proposed while the data entries are open, with the status identifier being changed to indicate that the transaction was submitted when the data entries are being closed. Further, the status identifier can indicate whether the transaction was a success, e.g., approved, or a failure, e.g., denied. Once the data entries have been closed, the processing device 102 can transmit the data entries to the blockchain nodes 106, which may then enter the data entries into their respective blockchains 104, e.g., the first blockchain data entry being entered into the first blockchain network 104a and the second blockchain data entry being entered into the first blockchain network 104b. In such cases, the issuer system 110 can view the status identifiers in blockchain data entries when identifying the blockchain data entry for use in identifying real payment details, where blockchain data entries with status identifiers indicating that the transaction was only proposed can be ignored.

The methods and systems discussed herein provide for the use of dynamic, reusable card numbers in e-commerce transactions via the use of blockchains that enable consumers to transact using their traditional transaction accounts, but where merchants are unable to track consumer activity. Because the dynamic card numbers are reusable and can be used by any consumer, the merchant is unable to make any one-to-one correlations, which prevents consumer data from being collected and sold without express permission from the consumer. By using a private blockchain to store data regarding real payment details and dynamic payment details, issuer systems 110 can participate to provide these benefits to consumers without the need to modify existing transaction accounts. Additionally, chargebacks and other subsequent transactions can occur via the dynamic payment details, preventing merchants from ever having access to the real payment details while still providing full account functionality to consumers and issuers. In addition, because the consumer's real payment details are never made available, the systems and methods discussed herein provide for even greater account security from fraud and theft on top of protecting consumer data privacy, providing for significant advantages over traditional systems.

### Processing Server

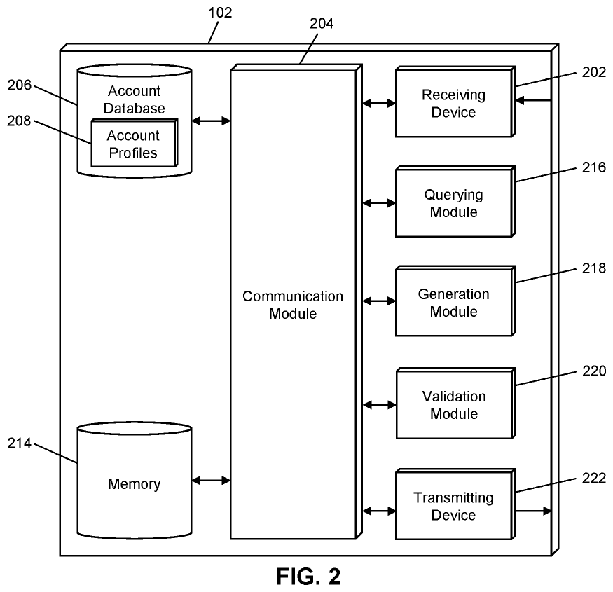

FIG. 2 illustrates an embodiment of the processing server 102 in the system 100 of FIG. 1. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 500 illustrated in FIG. 5 and discussed in more detail below can be a suitable configuration of the processing server 102. In some cases, other components of the system 100, such as the blockchain nodes 106, computing device 108, issuer system 110, and merchant system 112 can include the components illustrated in FIG. 2 and discussed below.

The processing server 102 can include a receiving device 202. The receiving device 202 can be configured to receive data over one or more networks via one or more network protocols. In some instances, the receiving device 202 can be configured to receive data from blockchain nodes 106, computing devices 108, issuer systems 110, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by blockchain nodes 106 that are superimposed or otherwise encoded with blockchain data entries, requests for blockchain data, and, in cases where the processing server 102 can be a blockchain node 106, other blocks, confirmation messages, etc. The receiving device 202 can also be configured to receive data signals electronically transmitted by computing devices 108, which can be superimposed or otherwise encoded with transaction requests, authentication data, approval messages, payment details, transaction data, dynamic payment detail requests, user-generated dynamic payment numbers, etc. The receiving device 202 can also be configured to receive data signals electronically transmitted by issuer systems 110 that are superimposed or otherwise encoded with real payment detail requests, which can include dynamic payment details and other identifying transaction data.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, validation module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include an account database 206. The account database 206 can be configured to store one or more account profiles 208 using a suitable data storage format and schema. The account database 206 can be a relational database that utilizes structured query language for the storage, identification, modifying, updating, accessing, etc. of structured data sets stored therein. Each account profile 208 can be a structured data set configured to store data related to a computing device 108 and/or a consumer. An account profile 208 can include, for example, real payment details, assigned dynamic payment details, user-generated dynamic payment details, transaction data, user preferences, etc. For instance, a consumer can save their real payment details with the processing server 102 for convenience when participating in e-commerce transactions using dynamic payment details. In cases where dynamic payment details can be provided to computing devices 108 ahead of use (e.g., for automatic inclusion in transaction submissions, as discussed above), indication of assignment and usage of dynamic payment details can be stored in account profiles 208. In cases where the dynamic payment number is user-generated and associated with a specific merchant, the mapping of the user-generated dynamic payment number and the associated merchant can be stored in the account profiles 208.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, transaction identifiers, dynamic card numbers and other dynamic payment details, routing information, transaction data, issuer data, blockchain data, etc.

The processing server 102 can include a querying module 216. The querying module 216 can be configured to execute queries on databases to identify information. The querying module 216 can receive one or more data values or query strings and can execute a query string based thereon on an indicated database, such as the account database 206 of the processing server 102 to identify information stored therein. The querying module 216 can then output the identified information to an appropriate engine or module of the processing server 102 as necessary. The querying module 216 can, for example, execute a query on the account database 206 to identify an account profile 208 based on data included in a received transaction request, such as to identify dynamic payment details for providing to a computing device 108 for a proposed electronic payment transaction.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate data messages, notification messages, blockchain data entries, transaction identifiers, dynamic card numbers, dynamic payment details, etc.

The processing server 102 can also include a validation module 220. The validation module 220 can be configured to perform data validations and verifications for the processing server 102 as part of the functions discussed herein. The validation module 220 can receive instructions as input, can perform data validations or verification as instructed, and can output a result of the data validations or verifications to one or more modules of the processing server 102. In some cases, the input can include the data to be validated or verified and/or data to be used in the validation or verification. In other cases, the validation module 220 can be configured to identify such data, such as in the account database 206 and/or memory 214. The validation module 220 can be configured to, for example, verify real payment details, transaction data, blockchain data entries, new blocks, etc.

The processing server 102 can also include a transmitting device 222. The transmitting device 222 can be configured to transmit data over one or more networks via one or more network protocols. In some instances, the transmitting device 222 can be configured to transmit data to blockchain nodes 106, computing devices 108, issuer systems 110, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to blockchain nodes 106 that are superimposed or otherwise encoded with blockchain data entries, blockchain data requests, blocks, confirmation messages, response messages, etc. The transmitting device 222 can also be configured to electronically transmit data signals to computing devices 108, which can be superimposed or otherwise encoded with dynamic payment details, notification messages, authorization messages, data request messages, etc. The transmitting device 222 can also be configured to electronically transmit data signals to issuer systems 110 that are superimposed or otherwise encoded with data requests, dynamic payment details, transaction data, etc.

### Process for Use of Dynamic Card Numbers in E-Commerce Transactions

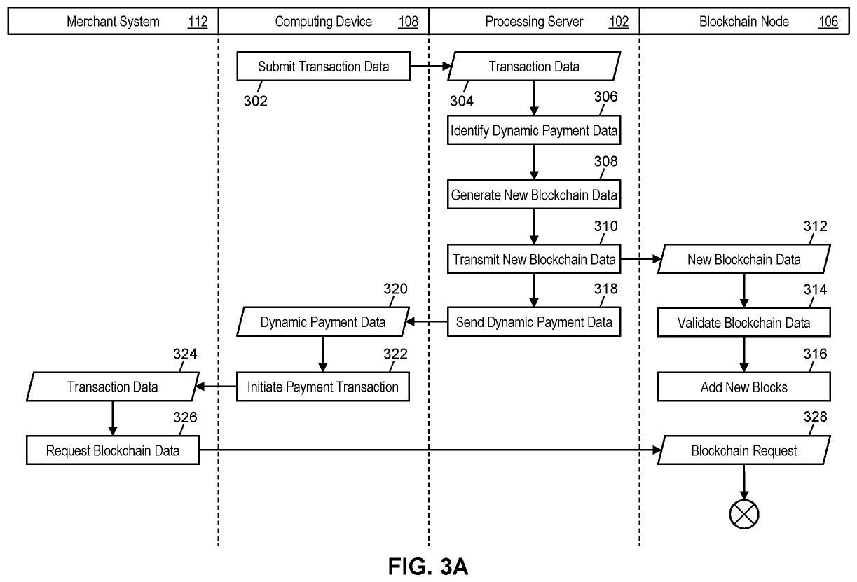

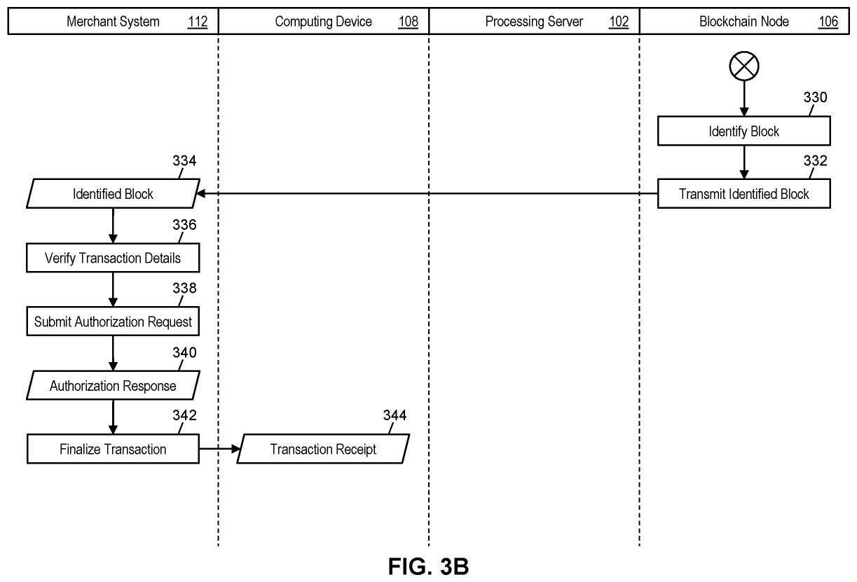

FIGS. 3A and 3B illustrate a process in the system 100 of FIG. 1 for the conducting of an electronic payment transaction with a dynamic card number via blockchain to protect consumer data privacy.

In step 302, the computing device 108, can electronically submit a transaction

request to the processing server 102 for a proposed electronic payment transaction via a suitable communication network and method. The transaction request can include transaction data for the proposed electronic payment transaction, such as a transaction amount, merchant identifier, time and/or date, etc., as well as real payment details for the transaction account that the user of the computing device 108 wants to use to fund the electronic payment transaction. In embodiments, the transaction request can include a user-generated dynamic payment number for use with the requested transaction. In step 304, the receiving device 202 of the processing server 102 can receive the transaction request. In step 306, the querying module 216 of the processing server 102 can identify dynamic payment details for use in the proposed electronic payment transaction, as discussed above. In embodiments where the dynamic payment number is user-generated, the processing server 102 can verify that the user-generated dynamic payment number is valid, e.g., available for use. In step 308, the generation module 218 of the processing server 102 can generate new blockchain data. The new blockchain data can include a first blockchain data entry that includes a transaction identifier, transaction data, real payment details, and identified dynamic payment details, and a second blockchain data entry that includes the transaction identifier, transaction identifier, and identified dynamic payment details. In embodiments, the first and second blockchain data entries may also include a status identifier for the requested transaction indicating the status of the requested transaction, e.g., open, closed, approved, denied, etc.

In step 310, the transmitting device 222 of the processing server 102 can electronically transmit the new blockchain data entries to one or more blockchain nodes 106 using suitable communication networks and methods. In embodiments, the processing server 102 may skip step 310 and proceed directly to step 318, keeping the new blockchain data entries open. In step 312, the blockchain nodes 106 can receive the new blockchain data entries. In step 314, the blockchain nodes 106 can validate the new blockchain data entries and, upon successful validation, generate new blocks that include the new blockchain data entries. In step 316, the new blocks can be confirmed and added to the respective blockchains, where the first blockchain data entry is included in a new block added to the first, private blockchain, and where the second blockchain data entry is included in a new block that is added to the second, permissioned blockchain.

In step 318, the transmitting device 222 of the processing server 102 can electronically transmit the identified dynamic payment details to the computing device 108 in response to the transaction request. In embodiments where the dynamic payment number is user-generated, the step 318 can include an approval of the user-generate dynamic payment number. In step 320, the computing device 108 can receive the dynamic payment details and/or the approval of the user-generated dynamic payment number. In step 322, the computing device 108 can initiate the proposed electronic payment transaction with the merchant by submitting the dynamic payment details and other transaction data to the merchant system 112 via a suitable method. In embodiments where the blockchain data entries are not transmitted to the blockchain nodes 106 at step 310, the computing device 108 may provide authentication data, such as a one-time password, for verification to the processing server 102 at step 322, at which time the processing server 102 may perform steps 312-316. In step 324, the merchant system 112 can receive the transaction data, including the dynamic payment details, from the computing device 108. In step 326, the merchant system 112 can electronically transmit a data request for blockchain data to a blockchain node 106b in the second blockchain network 104b, where the data request includes the dynamic payment details and/or other identifying transaction data. In step 328, the blockchain node 106b can receive the data request.

In step 330, the blockchain node 106b can identify the new block that includes the second blockchain data entry and, in step 332, transmit the second blockchain data entry back to the merchant system 112 using a suitable communication network and method. In step 334, the merchant system 112 can receive the second blockchain data entry from the blockchain node 106b. In step 336, the merchant system 112 can verify that the transaction data received from the computing device 108 matches the transaction data included in the second blockchain data entry. For instance, the merchant system 112 can verify that the transaction amounts match, such as to ensure that the transaction will be approved for the proper amount by the issuer system 110.

Upon successful verification, the merchant system 112 can, in step 338, submit an authorization request for a new payment transaction to the payment network 114 via the payment rails associated therewith. The authorization request can be a specially formatted transaction message that is formatted according to one or more standards governing the exchange of financial transaction messages, such as the International Organization of Standardization's ISO 8583 standard. The authorization request can include a message type indicator indicative of an authorization request as well as a plurality of data elements configured to store the transaction data, the transaction data including at least the dynamic payment details, transaction amount, and any other data, such as a time and/or date, merchant identifier, merchant category code, currency identifier, point of sale identifier, acquirer data, issuer data, etc. The payment transaction can be processed using the authorization request via traditional methods and systems. As part of the processing, the issuer system 110 that issued the real transaction account selected by the computing device 108 for funding of the electronic payment transaction can identify the real transaction account using the dynamic payment details and transaction data via the first blockchain data entry and approve the payment transaction for funding via the real transaction account.

Upon successful approval and processing of the electronic payment transaction, the merchant system 112 can, at step 340, receive an authorization response from the payment network 114 via the payment rails thereof, where the authorization response includes a response code indicating approval of the payment transaction. At step 342, the merchant system 112 can finalize the electronic payment transaction, such as by initiating the shipping of goods or providing of services purchased by the consumer thereto. As part of the finalizing, the merchant system 112 can generate a transaction receipt for the electronic payment transaction, which can be electronically transmitted to the computing device 108 via a suitable communication network and method. In step 344, the computing device 108 can receive the transaction receipt, which can be displayed to the consumer as a user thereof using a suitable display device. This process results in an electronic payment transaction that utilizes a dynamic card number and blockchain to protect consumer data privacy with minimal modification to existing transaction processing systems for convenience in use and adoption.

### Exemplary Method for Establishing Payment via a Dynamic Card Number

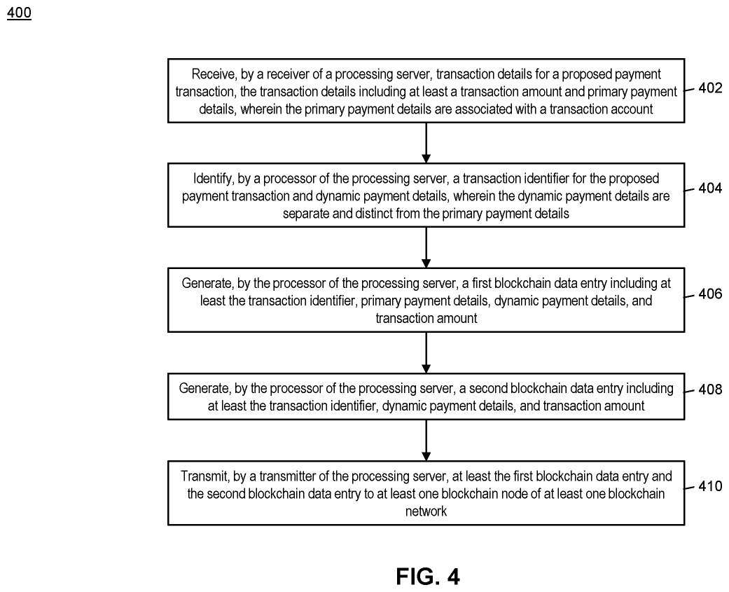

FIG. 4 illustrates a method 400 for establishing payment in an electronic payment transaction via a dynamic card number and blockchain in order to protect consumer data privacy and account security.

In step 402, transaction details for a proposed payment transaction can be received by a receiver (e.g., receiving device 202) of a processing server (e.g., processing server 102), the transaction details including at least a transaction amount and primary payment details (e.g., real payment details), wherein the primary payment details are associated with a transaction account. In step 404, a transaction identifier for the proposed payment transaction and dynamic payment details can be identified by a processor (e.g., querying module 216, generation module 218, etc.) of the processing server, wherein the dynamic payment details are separate and distinct from the primary payment details.

In step 406, a first blockchain data entry can be generated by the processor (e.g., generation module 218) of the processing server including at least the transaction identifier, primary payment details, dynamic payment details, and transaction amount. In step 408, a second blockchain data entry can be generated by the processor (e.g., generation module 218) of the processing server including at least the transaction identifier, dynamic payment details, and transaction amount. In step 410, at least the first blockchain data entry and the second blockchain data entry can be transmitted by a transmitter (e.g., transmitting device 222) of the processing server to at least one blockchain node (e.g., blockchain node 106) of at least one blockchain network (e.g., blockchain network 104).

In one embodiment, the method 400 can further include receiving, by the receiver of the processing server, a transaction authorization message, wherein the first blockchain data entry and the second blockchain data entry are transmitted in response to receipt of the transaction authorization message. In some embodiments, the transaction details can be received from a computing device (e.g., computing device 108) and the method 400 can further include transmitting, by the transmitter of the processing server, the identified dynamic payment details to the computing device. In a further embodiment, the method 400 can even further include receiving, by the receiver of the processing server, a transaction authorization message from the computing device in response to transmitting the identified dynamic payment details, wherein the first blockchain data entry and the second blockchain data entry are transmitted in response to receipt of the transaction authorization message.

In one embodiment, the first blockchain data entry can be transmitted to a first blockchain node (e.g., blockchain node 106a) in a first blockchain network (e.g., blockchain network 104a), and the second blockchain data entry can be transmitted to a second blockchain node (e.g., blockchain node 106b) in a second blockchain network (e.g., blockchain network 104b). In a further embodiment, a first blockchain associated with the first blockchain network can be a private blockchain, and a second blockchain associated with the second blockchain network can be a permissioned blockchain. In some embodiments, the first blockchain data entry and the second blockchain data entry can further include a time and/or date. In one embodiment, the method 400 can also include transmitting, by the transmitter of the processing server, at least the primary payment details and the dynamic payment details to an issuing financial institution (e.g., issuer system 110) associated with the transaction account.

### Computer System Architecture

FIG. 5 illustrates a computer system 500 in which embodiments of the present disclosure, or portions thereof, can be implemented as computer-readable code. For example, the processing server 102, blockchain nodes 106, computing device 108, issuer system 110, and merchant system 112 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3A, 3B, and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3A, 3B, and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for establishing payment via a dynamic card number using blockchain to protect consumer privacy. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for establishing payment via a dynamic card number using blockchain to protect consumer privacy, comprising:
receiving, by a receiver of a processing server, transaction details for a proposed payment transaction, the transaction details including at least a transaction amount and primary payment details, wherein the primary payment details are associated with a transaction account;
identifying, by a processor of the processing server, a transaction identifier for the proposed payment transaction and dynamic payment details, wherein the dynamic payment details are separate and distinct from the primary payment details;
generating, by the processor of the processing server, a first blockchain data entry including at least the transaction identifier, primary payment details, dynamic payment details, and transaction amount;
generating, by the processor of the processing server, a second blockchain data entry including at least the transaction identifier, dynamic payment details, and transaction amount; and
transmitting, by a transmitter of the processing server, at least the first blockchain data entry and the second blockchain data entry to at least one blockchain node of at least one blockchain network.

2. The method of claim 1, further comprising:
receiving, by the receiver of the processing server, a transaction authorization message, wherein the first blockchain data entry and the second blockchain data entry are transmitted in response to receipt of the transaction authorization message.

3. The method of claim 1, wherein
the transaction details are received from a computing device, and
the method further comprises:
transmitting, by the transmitter of the processing server, the identified dynamic payment details to the computing device.

4. The method of claim 3, further comprising:
receiving, by the receiver of the processing server, a transaction authorization message from the computing device in response to transmitting the identified dynamic payment details, wherein the first blockchain data entry and the second blockchain data entry are transmitted in response to receipt of the transaction authorization message.

5. The method of claim 1, wherein
the first blockchain data entry is transmitted to a first blockchain node in a first blockchain network, and
the second blockchain data entry is transmitted to a second blockchain node in a second blockchain network.

6. The method of claim 5, wherein
a first blockchain associated with the first blockchain network is a private blockchain, and
a second blockchain associated with the second blockchain network is a permissioned blockchain.

7. The method of claim 1, wherein the first blockchain data entry and the second blockchain data entry further include a time and/or date.

8. The method of claim 1, further comprising:
transmitting, by the transmitter of the processing server, at least the primary payment details and the dynamic payment details to an issuing financial institution associated with the transaction account.

9. A system for establishing payment via a dynamic card number using blockchain to protect consumer privacy, comprising:
at least one blockchain node;
at least one blockchain network including the at least one blockchain node; and
a processing server, the processing server including
a receiver receiving transaction details for a proposed payment transaction, the transaction details including at least a transaction amount and primary payment details, wherein the primary payment details are associated with a transaction account,
a processor
identifying transaction identifier for the proposed payment transaction and dynamic payment details, wherein the dynamic payment details are separate and distinct from the primary payment details,
generating a first blockchain data entry including at least the transaction identifier, primary payment details, dynamic payment details, and transaction amount, and
generating a second blockchain data entry including at least the transaction identifier, dynamic payment details, and transaction amount, and
a transmitter transmitting at least the first blockchain data entry and the second blockchain data entry to at least one blockchain node of at least one blockchain network.

10. The system of claim 9, wherein the receiver of the processing server receives a transaction authorization message, wherein the first blockchain data entry and the second blockchain data entry are transmitted in response to receipt of the transaction authorization message.

11. The system of claim 9, wherein
the transaction details are received from a computing device, and
the transmitter of the processing server transmits the identified dynamic payment details to the computing device.

12. The system of claim 11, wherein the receiver of the processing server receives a transaction authorization message from the computing device in response to transmitting the identified dynamic payment details, wherein the first blockchain data entry and the second blockchain data entry are transmitted in response to receipt of the transaction authorization message.

13. The system of claim 9, wherein
the first blockchain data entry is transmitted to a first blockchain node in a first blockchain network, and
the second blockchain data entry is transmitted to a second blockchain node in a second blockchain network.

14. The system of claim 13, wherein
a first blockchain associated with the first blockchain network is a private blockchain, and
a second blockchain associated with the second blockchain network is a permissioned blockchain.

15. The system of claim 9, wherein the first blockchain data entry and the second blockchain data entry further include a time and/or date.

16. The system of claim 9, wherein the transmitter of the processing server transmits at least the primary payment details and the dynamic payment details to an issuing financial institution associated with the transaction account.

17. A method for establishing payment via a dynamic card number using blockchain to protect consumer privacy, comprising:
receiving, by a receiver of a processing server, transaction details for a proposed payment transaction, the transaction details including at least a transaction amount, primary payment details, and dynamic payment details, wherein the primary payment details are associated with a transaction account and the dynamic payment details different than the primary payment details but associated with the primary payment details;
identifying, by a processor of the processing server, a transaction identifier for the proposed payment transaction;
generating, by the processor of the processing server, a first blockchain data entry including at least the transaction identifier, primary payment details, dynamic payment details, and transaction amount;
generating, by the processor of the processing server, a second blockchain data entry including at least the transaction identifier, dynamic payment details, and transaction amount; and
transmitting, by a transmitter of the processing server, at least the first blockchain data entry and the second blockchain data entry to at least one blockchain node of at least one blockchain network.

18. The method of claim 17, wherein
the transaction details are received from a computing device, and
the method further comprises:
verifying, by the processor of the processing server, the dynamic payment details; and
transmitting, by the transmitter of the processing server, an approval of the dynamic payment details to the computing device.

19. The method of claim 18, including:
receiving, by a receiver of a processing server, a transaction authorization message from the computing device, wherein the first blockchain data entry and the second blockchain data entry are transmitted in response to receipt of the transaction authorization message.

20. A system for establishing payment via a dynamic card number using blockchain to protect consumer privacy, comprising:
at least one blockchain node;
at least one blockchain network including the at least one blockchain node; and
a processing server, the processing server including
a receiver receiving transaction details for a proposed payment transaction, the transaction details including at least a transaction amount, primary payment details, and dynamic payment details, wherein the primary payment details are associated with a transaction account and the dynamic payment details different than the primary payment details but associated with the primary payment details,
a processor
identifying, by a processor of the processing server, a transaction identifier for the proposed payment transaction,
generating, by the processor of the processing server, a first blockchain data entry including at least the transaction identifier, primary payment details, dynamic payment details, and transaction amount,
generating, by the processor of the processing server, a second blockchain data entry including at least the transaction identifier, dynamic payment details, and transaction amount, and
a transmitter transmitting at least the first blockchain data entry and the second blockchain data entry to at least one blockchain node of at least one blockchain network.
